(19) United States
(12) Patent Application Publication
(10) Pub. No.: US 2026/0131659 A1
(43) Pub. Date: May 14, 2026

(54) VEHICLE AND METHOD OF CONTROLLING THE SAME

(71) Applicants: Hyundai Motor Company, Seoul (KR); Kia Corporation, Seoul (KR)

(72) Inventor: Hyung Ryul Yuk, Hwaseong (KR)

(21) Appl. No.: 19/226,842

(22) Filed: Jun. 3, 2025

(30) Foreign Application Priority Data
Nov. 12, 2024 (KR) 10-2024-0160037

(51) Int. Cl. B60L 3/00

(52) U.S. Cl. CPC B60L 3/0015; B60L 2240/622; B60L 2240/665; B60L 2270/42

(57) ABSTRACT

Provided is a vehicle including a sound output unit including a first speaker mounted at a front outside the vehicle and a second speaker mounted at a rear outside the vehicle, a sensor unit configured to collect vehicle driving information and object recognition information, a first processing unit configured to generate a reference sound using the vehicle driving information and the object recognition information, a second processing unit configured to generate a first sound and a second sound using the reference sound, and a third processing unit configured to control the first speaker to output the first sound and control the second speaker to output the second sound.

### CROSS-REFERENCE TO RELATED APPLICATION

This application claims under 35 U.S.C. § 119(a) the benefit of Korean Patent Application No. 10-2024-0160037, filed on Nov. 12, 2024, the disclosure of which is incorporated herein by reference in its entirety.

### BACKGROUND

### Technical Field

The present disclosure generally relates to automotive engineering and, more particularly, to systems and methods for generating and controlling vehicle sound output based on various sensor inputs. The disclosure leverages external speakers, sensor units, and signal processing units to produce tailored audio signals according to a vehicle's driving conditions and detected objects.

### BACKGROUND

As the development of electric vehicles continues to progress rapidly, there is a growing demand for driving sounds different from those of traditional internal combustion engine vehicles. Internal combustion engine vehicles naturally generate engine noise while traveling, but since electric vehicles do not have the engine noise, the electric vehicles, which lack such an engine noise, are noticeably quieter when in motion. This reduced noise makes it difficult for pedestrians or other drivers to recognize an approaching electrical vehicle, creating a need to artificially output certain sounds for enhanced safety.

To address this, technology has emerged to install front and rear speakers on the exterior of the electric vehicle to generate and output artificial driving sounds when the vehicle is in motion. The speakers may emit constant engine or driving sounds while the vehicle is traveling to notify pedestrians and other vehicles of movements of the vehicle. The technology is mainly based on a method of implementing a uniform driving sound by outputting the same sound from the front and rear speakers of the vehicle. The method simply focuses on notifying that the vehicle is moving by simultaneously playing back the same sound from the front and rear.

However, existing solutions generally focus on simply notifying others of the presence of the vehicle through sound output and offer limited ability to modulate or dynamically adapt the sound based on various driving conditions or situations.

In addition, sounds output at the same frequency and volume may serve to notify that the vehicle is moving, but the sounds are insufficient in conveying detailed information such as the speed or direction of the vehicle.

Therefore, there is a need for a more advanced approach that can clearly communicate the vehicle's driving status through diverse and high-performance sound effects.

### SUMMARY OF THE DISCLOSURE

The present disclosure is directed to providing a vehicle capable of maximizing high-performance sound effects suitable for various driving situations by independently adjusting sound output from front and rear speakers of the vehicle and a method of controlling the vehicle.

According to some example embodiments of the present disclosure, there is provided a vehicle including a sound output unit including a first speaker mounted at a front outside the vehicle and a second speaker mounted at a rear outside the vehicle, a sensor unit configured to collect vehicle driving information and object recognition information, a first processing unit configured to generate a reference sound using the vehicle driving information and the object recognition information, a second processing unit configured to generate each of a first sound to be played back from the first speaker and a second sound to be played back from the second speaker using the reference sound, and a third processing unit configured to control the first speaker to output the first sound and control the second speaker to output the second sound.

The second processing unit may generate the first sound and the second sound according to the vehicle driving information and the object recognition information.

The second processing unit may generate the first sound and the second sound by modulating a frequency of the reference sound.

The second processing unit may modulate the frequency of the reference sound so that frequencies of the first sound and the second sound are different from each other.

The second processing unit may generate the first sound by increasing the frequency of the reference sound and generate the second sound by reducing the frequency of the reference sound when the vehicle is traveling in a city or on a highway during a daytime.

The second processing unit may generate the first sound and the second sound by reducing a volume of the reference sound when the vehicle is traveling in a residential area at night.

The second processing unit may generate the first sound by increasing a frequency and a volume of the reference sound and generate the second sound by reducing the frequency and the volume of the reference sound when a pedestrian is recognized in a driving direction of the vehicle.

The second processing unit may generate the first sound and the second sound by adjusting a frequency and a volume of the reference sound according to a mode set through a user interface unit.

The first sound and the second sound may be different in at least one of frequency and volume.

The second processing unit may generate the first sound and the second sound of different frequencies having interference sounds by adjusting the frequency of the reference sound to within a preset range.

According to other example embodiments of the present disclosure, there is provided a method of controlling a vehicle, including collecting, by a sensor unit, vehicle driving information and object recognition information, generating, by a first processing unit, a reference sound using the vehicle driving information and the object recognition information, generating, by a second processing unit, each of a first sound to be played back from a first speaker mounted at a front outside the vehicle and a second sound to be played back from a second speaker mounted at a rear outside the vehicle using the reference sound, and controlling, by a third processing unit, the first speaker to output the first sound and controlling the second speaker to output the second sound.

The generating may include generating the first sound and the second sound according to the vehicle driving information and the object recognition information.

The generating may include generating the first sound and the second sound by modulating a frequency of the reference sound.

The generating may include modulating the frequency of the reference sound so that frequencies of the first sound and the second sound are different from each other.

The generating may include generating the first sound by increasing the frequency of the reference sound and generating the second sound by reducing the frequency of the reference sound when the vehicle is traveling in a city or on a highway during a daytime.

The generating may include generating the first sound and the second sound by reducing a volume of the reference sound when the vehicle is traveling in a residential area at night.

The generating may include generating, by the second processing unit, the first sound by increasing a frequency and a volume of the reference sound and generating, by the second processing unit, the second sound by reducing the frequency and the volume of the reference sound when a pedestrian is recognized in a driving direction of the vehicle.

The generating may include generating, by the second processing unit, the first sound and the second sound by adjusting a frequency and a volume of the reference sound according to a mode set through a user interface unit.

The first sound and the second sound may be different in at least one of frequency and volume.

The generating may include generating the first sound and the second sound of different frequencies having interference sounds by adjusting the frequency of the reference sound to within a preset range.

### BRIEF DESCRIPTION OF THE DRAWINGS

The above and other objects, features and advantages of the present disclosure will become more apparent to those of ordinary skill in the art by describing example embodiments thereof in detail with reference to the accompanying drawings, in which:

FIG. 1 is a view showing a vehicle transmitting and receiving data by communicating with another device, according to some embodiments of the present disclosure;

FIG. 2 is a diagram showing modules constituting a vehicle, according to some embodiments of the present disclosure;

FIG. 3 is a diagram for describing the operation of the vehicle according to some embodiments of the present disclosure;

FIG. 4 is a flow chart illustrating an example method for generating and controlling a reference sound in a vehicle, according to some embodiments of the present disclosure;

FIG. 5 is a schematic diagram showing how a second processing unit performs the reference sound into two distinct audio outputs, according to some embodiments of the present disclosure;

FIG. 6 is a schematic diagram depicting how a third processing unit manages the output of the first and second sounds through exterior speakers, according to some embodiments of the present disclosure.

FIG. 7 is a flowchart demonstrating how the system dynamically adjusts sound parameters based on various driving scenarios, according to some embodiments of the present disclosure; and

FIG. 8 is a flowchart of a method of controlling a vehicle, according to some embodiments of the present disclosure.

### DETAILED DESCRIPTION OF EXAMPLE EMBODIMENTS

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction, and a downward direction based on one component.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “reference sound” as used herein refers to a fundamental audio signal or baseline tone generated based on vehicle driving information and object recognition information, which serves as the source for producing other output sounds.

The term “mode” as used herein refers to a user-selectable or system-determined operational setting that influences how the reference sound is processed.

The term “user interface unit” as used herein refers to any device or software interface (e.g., a dashboard touch screen, mobile app, or control panel) that allows an operator or passenger to interact with the vehicle's audio output settings, change system modes, or input preferences related to the sounds generated by the processing units.

Hereinafter, embodiments will be described in detail with reference to the accompanying drawings, but the same or corresponding components are denoted by the same reference numerals regardless of the drawing numbers, and redundant descriptions thereof will be omitted.

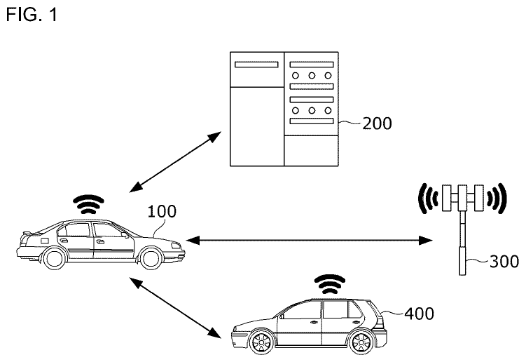

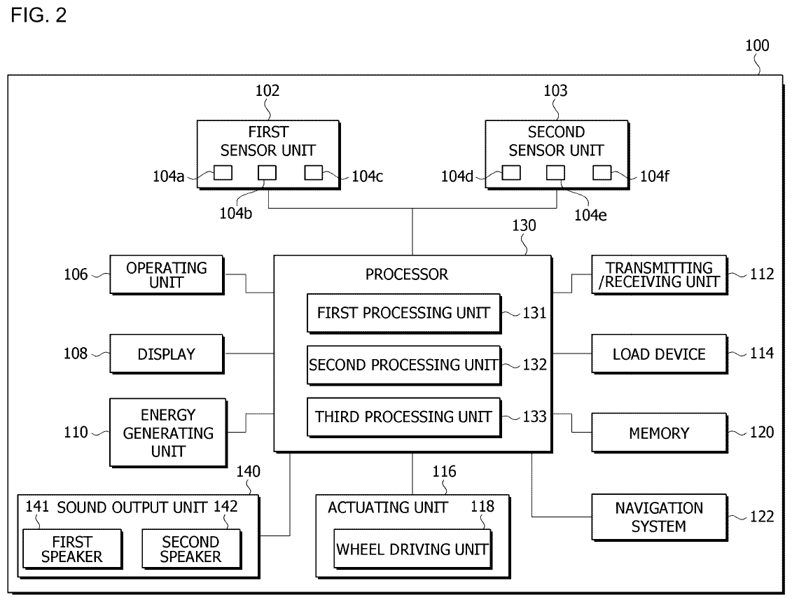

Hereinafter, a vehicle will be described with reference to FIGS. 1 and 2. FIG. 1 is a view illustrating a vehicle transmitting and receiving data by communicating with another device.

Referring to FIG. 1, a vehicle 100 may be driven based on electrical energy or fossil energy. In the case of electrical energy, the vehicle 100 may be, for example, a pure battery-based vehicle driven only by a high-voltage battery or may employ a gas-based fuel cell as an energy source. In addition, the fuel cell may use various types of gas capable of generating electrical energy, and the vehicle 100 may be filled with gas in a liquefied state, for example. Here, the gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules constituting a vehicle according to one embodiment of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, user operation, and a boarding space of the vehicle 100.

Specifically, the first sensor unit 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object. In the embodiment, external objects may be various objects related to the operation of the vehicle 100.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current vehicle position to a destination on a map when the destination has been set. When no destination is set, the route information may refer to information including a road on which a host vehicle is currently traveling and a future driving route including the road.

A third sensor unit 105 may include a voice sensor 105a that collects voice signals inside the vehicle, a vibration sensor 105b disposed around the occupant, and a camera 105c that captures the inside of the vehicle.

The voice sensor 105a may include at least one microphone disposed inside the vehicle and may collect voices and humming sounds expressed by the occupant inside the vehicle to generate a voice signal.

The vibration sensor 105b may include at least one acceleration sensor or gyro sensor disposed at a position where the occupant's body may touch and may generate a vibration signal by measuring vibration generated when a steering wheel, a console box, or a dashboard is tapped inside the vehicle.

The camera 105c may capture the inside of the vehicle and may be disposed to face the front of the upper body of the occupant, thereby generating a video signal capturing the movements of the occupant.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 is mounted on the vehicle 100 and may be a type of non-driving electrical device excluding a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. In addition, when the vehicle 100 is of a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. According to the embodiment, the navigation unit 122 may be classified as a sub-component of the operating unit 106.

A sound output unit 140 may convert an electrical signal provided from the processor 130 into an audio signal and output the audio signal. To this end, the sound output unit 140 may include one or more speakers.

The sound output unit 140 may include a first speaker 141 mounted at the front outside the vehicle and a second speaker 142 mounted at the rear outside the vehicle. In the following embodiments, the first speaker 141 and the second speaker 142 may be used with the same meaning as external speakers.

Each of the first speaker 141 and the second speaker 142 may include a speaker unit including a vibrating plate (cone), a coil (voice coil), a magnet, and a suspension.

The vibrating plate is a key component that transmits sound to the outside and may convert electrical signals into mechanical vibrations.

The voice coil may form a magnetic field when an electrical signal flows therethrough and interacts with the magnet to vibrate the vibrating plate.

The magnet may generate a magnetic field that interacts with the voice coil to move the vibrating plate.

The suspension serves to support the vibrating plate so that the vibrating plate may precisely vibrate and may provide freedom of movement.

The first speaker 141 and the second speaker 142 may be configured as full-range speakers. The first speaker 141 and the second speaker 142 may reproduce a wide frequency band from low to high sounds using a single speaker unit.

The processor may control the operation of the first speaker 141 and the second speaker 142 and generate sound signals in conjunction with various systems of the vehicle. The processor may adjust sounds output depending on the vehicle speed, ambient noise, and traffic conditions.

The processor may be connected to a controller area network bus (CAN) system of the vehicle and may transmit sound signals to the first speaker 141 and the second speaker 142.

The processor may output a customized sound that matches a characteristic of the vehicle. The sound may be designed to be similar to engine sounds or to be natural sounds suitable for surroundings.

The processor may adjust the timbre, frequency, and volume of the sound in real time using digital signal processing technology. For example, the processor may adjust the frequency and volume of the sound to naturally increase as the vehicle speed increases.

Since the first speaker 141 and the second speaker 142 are exposed to the external environment, waterproofing, dustproofing, and shock resistance may be implemented.

A housing is mounted on a protective case of the speaker and may be made of durable materials such as aluminum, reinforced plastic, carbon fibers, or the like.

A rubber seal and gasket may be used between the speaker and the housing to prevent water from penetrating inside.

The first speaker 141 and the second speaker 142 may be equipped with a damper and a shock absorber to absorb vibration and shock generated in the external environment. The damper and the shock absorber may help protect the speaker unit from external impact and prevent sound quality from being affected.

The first speaker 141 and the second speaker 142 may be equipped with a heat sink for efficiently dissipating heat generated when an electronic component operates. The heat sink may prevent speaker performance degradation when the external temperature is high.

In addition, there may be vents for quickly dissipating heat inside the speaker housing, and the vents may prevent heat damage.

After a digital sound file is processed inside the processor, the processed digital sound file may be converted into an analog signal and the converted analog signal may be output to the speaker unit. When an electrical signal is transmitted to the voice coil of the speaker unit, the vibrating plate may begin to vibrate through interaction with the magnet, and the vibrating plate vibrates the air, allowing sound to be output to the outside.

The generated sound may be transmitted to the outside through a waterproof/dustproof structure of the speaker, and a specific sound, such as a warning sound, an engine sound, or the like, may be transmitted to pedestrians or surrounding vehicles.

In addition, the vehicle 100 may include a memory 120 and a processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

The processor 130 may include a first processing unit 131, a second processing unit 132, and a third processing unit 133.

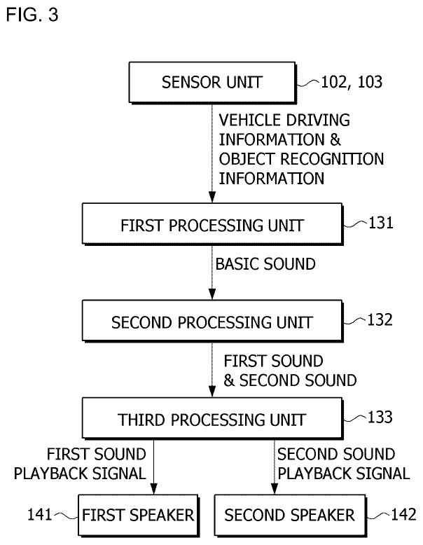

FIG. 3 is a diagram for describing the operation of the vehicle according to the embodiment. Referring to FIG. 3 together, the first processing unit 131 may generate a reference sound using vehicle driving information and object recognition information.

The first processing unit 131 may operate by collecting vehicle driving information, environmental information, and pedestrian and obstacle information collected from the sensor unit in real time and generating an adaptive sound based on the collected information. The first processing unit 131 may automatically adjust a sound coming from the external speakers of the vehicle to suit the driving environment by utilizing various types of data such as the speed, position, and time section of the vehicle, presence of pedestrians, and states of external obstacles. The adjusted sound may be particularly useful for quiet vehicles, such as electric vehicles (EVs) or hybrid vehicles, to provide a warning sound to pedestrians or to emit an appropriate sound in certain situations.

The sound played back from the external speakers of the vehicle may be generated in real time by considering surrounding conditions of the vehicle, and to this end, the first processing unit 131 may analyze the driving environment using various sensors and data.

For example, the first processing unit 131 may identify a current position of the vehicle through GPS, analyze an area (a city center, residential area, highway, or the like) in which the vehicle is traveling, and generate a reference sound. For example, in an urban area, since vehicles may need to more carefully interact with pedestrians, appropriate warning or driving sounds may be required.

For example, the first processing unit 131 may generate the reference sound by setting the sound intensity differently in residential areas, commercial areas, school areas, or the like, utilizing map data.

For example, the first processing unit 131 may determine whether the vehicle is traveling at a high speed or a low speed and adjust the size and frequency of sounds of the external speakers to generate the reference sound. When traveling at the low speed, a higher frequency and lower volume sound may be appropriate, while when traveling at the high speed, the frequency of the sound may be lowered, or the warning sound may be omitted.

For example, the first processing unit 131 may generate the reference sound by setting the sound of the external speakers differently depending on whether the vehicle is traveling during the day or at night. At night, a quieter sound may be used to minimize noise, while during the day, a louder sound may be used to warn pedestrians or other vehicles.

For example, the first processing unit 131 may generate the reference sound using a sound that is smaller or softer during night driving than during the day.

For example, the first processing unit 131 may generate the reference sound by adjusting the sound played back from the external speakers of the vehicle according to a distance, a position, and a movement direction of a pedestrian in front of and around the vehicle.

For example, the first processing unit 131 may generate the reference sound by making the warning sound louder when a pedestrian is close to the vehicle and making a lower sound or omitting the sound when the pedestrian is far away.

For example, when the radar and ultrasonic sensor of the vehicle detect an obstacle around the vehicle, the first processing unit 131 may generate the reference sound by reflecting the detection of an obstacle in the sound coming from the external speakers. The first processing unit 131 may increase the warning sound or output a specific warning sound to notify drivers and pedestrians when there is an obstacle.

In addition, the first processing unit 131 may generate the reference sound so that the intensity and type of the sound change depending on a distance between the obstacle and the vehicle.

The second processing unit 132 may generate a first sound to be played back from the first speaker 141 and a second sound to be played back from the second speaker 142 using the reference sound.

The first sound and the second sound may be different in at least one of frequency and volume.

For example, the second processing unit 132 may generate the first sound and the second sound according to the vehicle driving information and the object recognition information.

In addition, the second processing unit 132 may generate the first sound and the second sound by modulating the frequency of the reference sound. For example, the second processing unit 132 may modulate the frequency of the reference sound so that the frequencies of the first sound and the second sound are different from each other.

In addition, the second processing unit 132 may generate the first sound and the second sound by adjusting the frequency and the volume of the reference sound according to a mode set through a user interface unit.

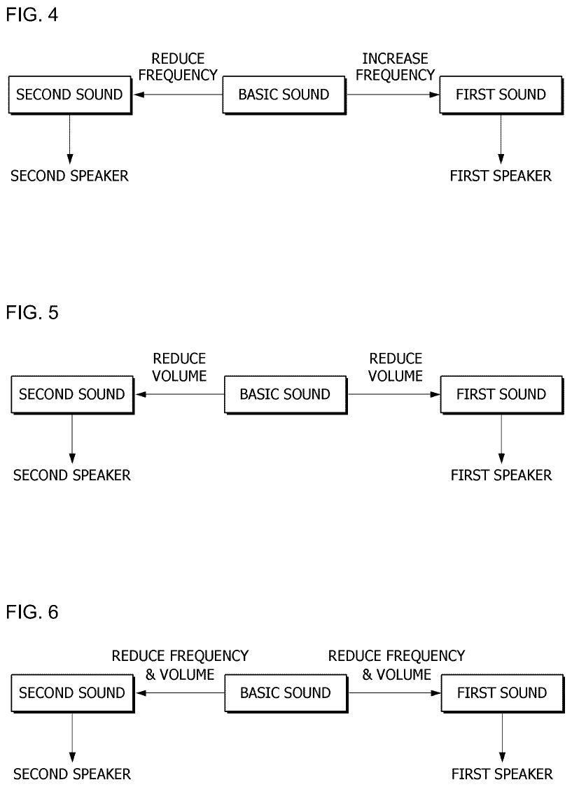

FIG. 4 is a diagram for describing the operation of the second processing unit according to the embodiment. Referring to FIG. 4 together, when it is determined that the vehicle is traveling in a city or on a highway during a daytime based on the vehicle driving information and the object recognition information, the second processing unit 132 may increase the frequency of the reference sound to generate the first sound and reduce the frequency of the reference sound to generate the second sound. In this way, an effect similar to the Doppler Effect may be produced.

The Doppler effect refers to a phenomenon in which sound waves are compressed and frequencies thereof increase when a sound source is approaching an observer, and sound waves are expanded, and frequencies thereof reduce when the sound source is moving away from the observer.

The second processing unit 132 may modulate sound wave frequencies of the first sound and the second sound in real time according to the speed and direction of the vehicle and the position of the observer. The process may allow pedestrians and other drivers to audibly recognize that the vehicle is approaching.

The second processing unit 132 may modulate the frequency of the reference sound in a method which increases the sound wave frequency of the first sound to be higher than that of the second sound when the vehicle is moving forward and increases the sound wave frequency of the second sound to be higher than that of the first sound when the vehicle is moving backwards.

That is, the second processing unit 132 may set the frequency of the first sound higher based on the speed of the vehicle when the vehicle is moving forward. As the speed of the vehicle increases, the frequency of the first sound increases, and accordingly, pedestrians and surrounding vehicles may audibly recognize that the vehicle is approaching.

The second processing unit 132 may reduce the frequency of the second sound when the vehicle is moving forward, as opposed to the above. Therefore, the sound waves coming from the second speaker 142 have a lower frequency as the vehicle is moving away, which may give an observer the feeling that the vehicle is moving away.

For example, when the vehicle is moving forward at 30 km/h, the second processing unit 132 may up-modulate the frequency of the first sound to 700 Hz and down-modulate the frequency of the second sound to 300 Hz.

The second processing unit 132 may perform the modulation so that the frequency changes of the front and rear speakers are opposite when the vehicle is moving backwards.

That is, the second processing unit 132 may perform the modulation so that the frequency of the second sound increases, and the frequency of the first sound reduces when the vehicle is moving backwards. This type of modulation may give pedestrians or other drivers an audible warning that the vehicle is approaching from behind. As the reverse speed of the vehicle increases, the frequency of the second sound increases, and accordingly, pedestrians and surrounding vehicles may audibly recognize that the vehicle is approaching.

For example, when the vehicle is moving backwards at 20 km/h, the second processing unit 132 may up-modulate the frequency of the second sound to 600 Hz and down-modulate the frequency of the first sound to 400 Hz.

The frequency modulation of the external speakers of the vehicle using the Doppler effect may play an important role in improving pedestrian safety, especially in notifying of the approach of vehicles having little engine noise, such as electric vehicles. In addition, sound effects similar to a supercar engine may be produced.

FIG. 5 is a diagram for describing the operation of the second processing unit according to the embodiment. Referring to FIG. 5 together, the second processing unit 132 may generate the first sound and the second sound by reducing the volume of the reference sound when the vehicle is traveling in a residential area at night.

The second processing unit 132 may reduce the volume of the reference sound so that the vehicle does not emit unnecessary noise to the outside when the vehicle is traveling at night, passing through a quiet residential area, or traveling below a certain speed.

The second processing unit 132 may adjust the volume of the sound signal output from the first speaker 141 and the second speaker 142 by gradually reducing the volume or completely eliminating the volume under certain conditions. In this way, unnecessary noise to pedestrians or people around the vehicle may be minimized, and the vehicle may move almost silently in certain situations.

For example, the second processing unit 132 may reduce the volume of the reference sound when a traveling speed of the vehicle is a certain speed or less (e.g., 20 km/h or less), when the vehicle is passing through a residential area based on GPS data or map information, or when the vehicle is traveling at night (e.g., after 22:00).

Alternatively, the second processing unit 132 may reduce the volume of the reference sound depending on user settings.

The second processing unit 132 may adjust the volume of the sound by differently reducing the volume of the first sound and the second sound.

The second processing unit 132 may gradually reduce the volume of the first sound when the vehicle is moving forward. Thereby, pedestrians and surrounding vehicles may feel as if the vehicle is silently moving. In this time, the second processing unit 132 may set the second sound to a relatively lower volume or maintain the second sound to be a finer sound according to the speed of the vehicle.

For example, when the vehicle is moving at 20 km/h, the second processing unit 132 may generate the first sound by reducing the volume of the reference sound by 50%, and may generate the second sound by reducing the volume of the reference sound by 70%.

When the vehicle is moving backwards, the second processing unit 132 may gradually reduce the volume of the second sound, thereby minimizing noise to pedestrians or the surrounding environment when the vehicle is moving backwards. For example, the volume of the first sound may be set to a relatively low level compared to the rear and may become almost silent when the vehicle is moving backwards.

For example, the second processing unit 132 may generate the second sound by reducing the volume of the reference sound to 40% when the vehicle is moving backwards, and may generate the first sound by muting the reference sound.

Through the volume adjustment, vehicle noise in residential areas may be reduced and noise pollution in the surrounding environment may be minimized. In addition, through the volume adjustment, the power consumption of speakers may be reduced, thereby contributing to increasing the energy efficiency of electric and hybrid vehicles.

The second processing unit 132 may generate the first sound and the second sound without reducing the volume when a pedestrian is recognized in the driving direction even when the vehicle enters a residential area.

FIG. 6 is a diagram for describing the operation of the second processing unit according to the embodiment. Referring to FIG. 6 together, when a pedestrian is recognized in the driving direction of the vehicle, the second processing unit 132 may generate the first sound by increasing the frequency and the volume of the reference sound, and generate the second sound by reducing the frequency and the volume of the reference sound.

The second processing unit 132 may dynamically adjust the frequency and the volume of the sound output from the first speaker 141 and the second speaker 142 near the pedestrian to warn the pedestrian of the approach of the vehicle. In this way, when the vehicle detects a pedestrian, the first speaker 141 may emit a warning sound with a higher frequency and a higher volume, and the second speaker 142 may reduce the sound or make the sound silent so that the sound is focused forward. In this way, the pedestrians may clearly recognize the approach of the vehicle.

For example, in a situation where the vehicle is approaching the pedestrian at a speed of 30 km/h or less, when the pedestrian is within 10 m of the vehicle, the second processing unit 132 may generate the first sound by increasing the frequency and the volume of the reference sound, and may generate the second sound by reducing the frequency and the volume of the reference sound.

The second processing unit 132 may increase the frequency of the first sound to generate the first sound having a high-frequency warning sound. Since higher frequencies are more audible to the human ear, the pedestrian may more quickly recognize the approaching vehicle. For example, the frequency of the reference sound, which has been set to 500 Hz, may be increased to 700 Hz or more to generate the first sound having a stronger warning tone.

In addition, the second processing unit 132 may generate the first sound by increasing the volume of the reference sound to clearly convey the warning sound to the pedestrian. For example, when the volume of the reference sound is set to 30%, the second processing unit 132 may generate the reference sound by increasing the volume to 70% or more.

The second processing unit 132 may reduce the volume of the second sound as much as possible or lower the frequency so as not to conflict with the front sound.

For example, when the frequency of the reference sound is 500 Hz, the second processing unit 132 may generate the second sound by reducing the frequency of the reference sound to 400 Hz or less to make the second sound less prominent compared to the sound coming from the front.

In addition, by reducing the volume of the reference sound to generate the second sound, the sound coming from the rear may be prevented from confusing the pedestrian. For example, when the volume of the reference sound is 30%, the second sound may be generated by reducing the volume of the reference sound to 10% or less.

Since a time point at which a warning is to be given to the pedestrian becomes more important as the vehicle travels faster, the second processing unit 132 may generate the first sound by more significantly increasing the frequency and the volume of the reference sound as the vehicle speed increases.

When the vehicle is slowly traveling, the second processing unit 132 may use a relatively low frequency and volume, thereby preventing unnecessary excessive noise from being generated.

In addition, the second processing unit 132 may generate the first sound by more significantly increasing the frequency and the volume of the reference sound as the pedestrian gets closer to the vehicle.

For example, the second processing unit 132 may generate the first sound by increasing the reference sound having a frequency of 500 Hz to a frequency of 600 Hz and increasing the volume to 110% when the vehicle is approaching the pedestrian at a distance of 30 m at a speed of 30 km/h.

For example, the second processing unit 132 may generate the first sound by increasing the reference sound having a frequency of 500 Hz to a frequency of 700 Hz and increasing the volume to 120% when the vehicle is approaching the pedestrian at a distance of 10 m at a speed of 20 km/h.

For example, the second processing unit 132 may generate the first sound by increasing the reference sound having a frequency of 500 Hz to a frequency of 800 Hz and increasing the volume to 130% when the vehicle is approaching the pedestrian at a distance of 5 m at a speed of 10 km/h.

For example, the second processing unit 132 may perform adjustment by reducing the frequency of the reference sound from 500 Hz to 400 Hz and reducing the volume to 70% so as not to confuse the pedestrian.

In this way, the pedestrian may recognize the approach of the vehicle in advance, thereby preventing an accident.

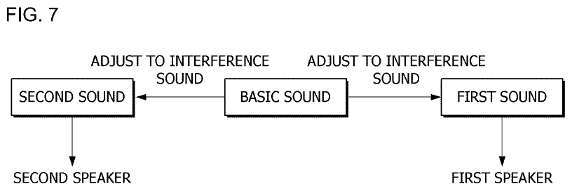

FIG. 7 is a diagram for describing the operation of the second processing unit according to the embodiment. Referring to FIG. 7 together, the second processing unit 132 may generate first and second sounds of different frequencies having interference sounds by adjusting the frequency of the reference sound to within a preset range. In this way, it is possible to generate a sound effect of a beat effect. The beat effect refers to a periodic amplitude change generated by mutual interference when two sounds having similar frequencies occur at the same time. For example, when sounds of 500 Hz and 510 Hz occur at the same time, the interference of the two sounds may cause an amplitude fluctuation of 10 Hz (beat). The beat effect appears more slowly when a frequency difference is smaller, and more quickly when the frequency difference is larger.

The second processing unit 132 may generate the first sound and the second sound with slightly different frequencies when the vehicle is moving, so that interference occurs between the two frequencies and the beat effect occurs.

For example, the second processing unit 132 may modulate the frequency of the reference sound so that the first sound has a frequency of 500 Hz, and may modulate the frequency of the reference sound so that the second sound has a frequency of 505 Hz. The difference between the two frequencies is 5 Hz, and a 5 Hz beat may occur due to the difference.

In addition, the second processing unit 132 may adjust the frequency difference between the first sound and the second sound according to the speed of the vehicle. The second processing unit 132 may generate the first sound at a frequency of 500 Hz and the second sound at a frequency of 515 Hz when the vehicle is moving at high speed, thereby inducing a beat frequency of 15 Hz.

Conversely, the second processing unit 132 may reduce the frequency difference between the first sound and the second sound to adjust the beat frequency to be slow when the speed of the vehicle slows down. The second processing unit 132 may adjust the frequency so that a beat of about 2 to 3 Hz appears when the speed is very slow.

When the vehicle is in a stopped state, the second processing unit 132 may generate the first sound and the second sound with the same frequency to prevent the occurrence of the beat. This is to ensure that the movement of the vehicle is audibly recognized only while the vehicle is traveling and to prevent unnecessary sound changes when the vehicle is stopped.

In this way, pedestrians and surrounding vehicles may clearly recognize that the vehicle is moving through the beat and may detect a situation where the vehicle is approaching or moving away through sound. This may provide an effect similar to that of outputting a siren sound to surrounding vehicles and pedestrians.

The third processing unit 133 may control the first speaker 141 to output the first sound and control the second speaker 142 to output the second sound.

The third processing unit 133 may perform signal processing so that the first sound and the second sound are synchronized to be simultaneously output through the first speaker 141 and the second speaker 142, respectively. The third processing unit 133 may analyze the first sound and the second sound generated by the second processing unit 132 to match the phases of the sounds and perform control so that no delay (delay time) occurs between the two speakers.

The third processing unit 133 may perform control so that the sounds output from the first speaker 141 and the second speaker 142 are synchronized without a phase difference so as not to be distorted or misaligned.

In addition, the third processing unit 133 may correct the delay time of the sound caused by a physical distance between the first speaker 141 and the second speaker 142. The third processing unit 133 may correct the physical delay so that the first sound and the second sound simultaneously arrive without delay.

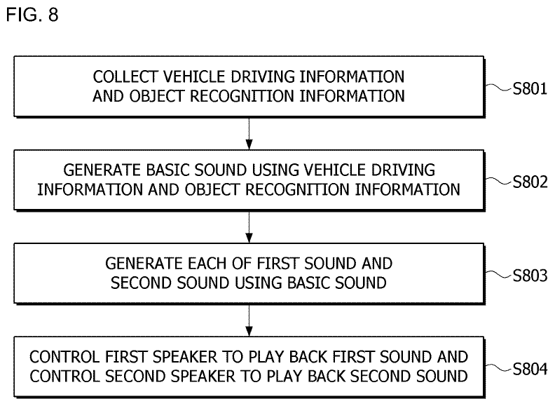

FIG. 8 is a flowchart of the method of controlling a vehicle according to the embodiment. Referring to FIG. 8, the sensor unit collects vehicle driving information and object recognition information (S801).

Next, the first processing unit generates a reference sound using the vehicle driving information and the object recognition information (S802).

Next, the second processing unit uses the reference sound to generate each of a first sound to be played back from the first speaker mounted at the front outside the vehicle and a second sound to be played back from the second speaker mounted at the rear outside the vehicle. The second processing unit generates the first sound and the second sound according to the vehicle driving information and the object recognition information (S803).

For example, when the vehicle is traveling in a city or on a highway during the daytime, the second processing unit increases a frequency of the reference sound to generate the first sound, and reduces the frequency of the reference sound to generate the second sound. For example, the second processing unit increases the frequency of the first sound in proportion to the speed of the vehicle.

For example, when the vehicle is traveling in a residential area at night, the second processing unit generates the first sound and the second sound by reducing a volume of the reference sound.

For example, when a pedestrian is recognized in a driving direction of the vehicle, the second processing unit generates the first sound by increasing the frequency and the volume of the reference sound, and generates the second sound by reducing the frequency and the volume of the reference sound. For example, the second processing unit increases the frequency and the volume of the first sound in proportion to a distance from the pedestrian and/or a speed of the vehicle.

For example, the second processing unit adjusts the frequency of the reference sound to within a preset range according to user settings and generates the first and second sounds of different frequencies having interference sounds. For example, the second processing unit adjusts a difference value between the first frequency and the second frequency according to the user settings.

Next, the third processing unit controls the first speaker to output the first sound and controls the second speaker to output the second sound (S804).

The term “˜unit” used in the present embodiment refers to software component or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

With a vehicle according to an embodiment and a method of controlling the vehicle, by independently adjusting sounds output from front and rear speakers of the vehicle, it is possible to maximize high-performance sound effects suitable for various driving situations.

In addition, in this way, apart from a monotonous sound output function, it is possible to implement various sound effects according to various information such as a speed, a direction, an environment, and the like, of a vehicle.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A vehicle comprising:
a sound output unit comprising a first speaker mounted at a front outside the vehicle and a second speaker mounted at a rear outside the vehicle;
a sensor unit configured to collect vehicle driving information and object recognition information;
a first processing unit configured to generate a reference sound using the vehicle driving information and the object recognition information;
a second processing unit configured to generate a first sound and a second sound using the reference sound; and
a third processing unit configured to control the first speaker to output the first sound and control the second speaker to output the second sound.

2. The vehicle of claim 1, wherein the second processing unit is configured to generate the first sound and the second sound according to the vehicle driving information and the object recognition information.

3. The vehicle of claim 2, wherein the second processing unit is configured to generate the first sound and the second sound by modulating a frequency of the reference sound.

4. The vehicle of claim 3, wherein the second processing unit is configured to modulate the frequency of the reference sound so that frequencies of the first sound and the second sound are different from each other.

5. The vehicle of claim 4, wherein the second processing unit is configured to generate the first sound by increasing the frequency of the reference sound and generates the second sound by reducing the frequency of the reference sound when the vehicle is traveling in a city or on a highway during a daytime.

6. The vehicle of claim 2, wherein the second processing unit is configured to generate the first sound and the second sound by reducing a volume of the reference sound when the vehicle is traveling in a residential area at night.

7. The vehicle of claim 2, wherein the second processing unit is configured to generate the first sound by increasing a frequency and a volume of the reference sound and generate the second sound by reducing the frequency and the volume of the reference sound when a pedestrian is recognized in a driving direction of the vehicle.

8. The vehicle of claim 1, wherein the second processing unit is configured to generate the first sound and the second sound by adjusting a frequency and a volume of the reference sound according to a mode set through a user interface unit.

9. The vehicle of claim 8, wherein the first sound and the second sound are different in at least one of frequency and volume.

10. The vehicle of claim 1, wherein the second processing unit is configured to generate the first sound and the second sound at different frequencies so as to produce interference sounds, by adjusting the frequency of the reference sound within a preset range.

11. A method of controlling a vehicle, the method comprising:
collecting, by a sensor unit, vehicle driving information and object recognition information;
generating, by a first processing unit, a reference sound using the vehicle driving information and the object recognition information;
generating, by a second processing unit, a first sound and a second sound using the reference sound; and
controlling, by a third processing unit, the first speaker mounted at a front outside of the vehicle to output the first sound and controlling the second speaker mounted at a rear outside of the vehicle to output the second sound.

12. The method of claim 11, wherein the generating, by the second processing unit, the first sound and the second sound using the reference sound comprises generating the first sound and the second sound according to the vehicle driving information and the object recognition information.

13. The method of claim 12, wherein the generating, by the second processing unit, the first sound and the second sound using the reference sound comprises generating the first sound and the second sound by modulating a frequency of the reference sound.

14. The method of claim 13, wherein the generating, by the second processing unit, the first sound and the second sound using the reference sound comprises modulating the frequency of the reference sound so that frequencies of the first sound and the second sound are different from each other.

15. The method of claim 14, wherein the generating, by the second processing unit, the first sound and the second sound using the reference sound comprises generating the first sound by increasing the frequency of the reference sound and generating the second sound by reducing the frequency of the reference sound when the vehicle is traveling in a city or on a highway during a daytime.

16. The method of claim 12, wherein the generating, by the second processing unit, the first sound and the second sound using the reference sound comprises generating the first sound and the second sound by reducing a volume of the reference sound when the vehicle is traveling in a residential area at night.

17. The method of claim 12, wherein the generating, by the second processing unit, the first sound and the second sound using the reference sound comprises generating, by the second processing unit, the first sound by increasing a frequency and a volume of the reference sound and generating, by the second processing unit, the second sound by reducing the frequency and the volume of the reference sound when a pedestrian is recognized in a driving direction of the vehicle.

18. The method of claim 11, wherein the generating, by the second processing unit, the first sound and the second sound using the reference sound comprises generating, by the second processing unit, the first sound and the second sound by adjusting a frequency and a volume of the reference sound according to a mode set through a user interface unit.

19. The method of claim 18, wherein the first sound and the second sound are different in at least one of frequency and volume.

20. The method of claim 11, wherein the generating, by the second processing unit, the first sound and the second sound using the reference sound comprises generating the first sound and the second sound at different frequencies so as to produce interference sounds, by adjusting the frequency of the reference sound within a preset range.
